(19) United States
(12) Patent Application Publication
(10) Pub. No.: US 2004/0039611 A1
(43) Pub. Date: Feb. 26, 2004

(54) Method and system of calculating an automobile insurance premium using a smart card

(76) Inventors: Seok-Woo Hong, Seoul (KR); Eun-Chul Cho, Seoul (KR)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/286,536

(22) Filed: Oct. 31, 2002

(30) Foreign Application Priority Data
Aug. 21, 2002 (KR) 2002-49534

(51) Int. Cl. G06F 17/60

(52) U.S. Cl. 705/4

(57) ABSTRACT

Method and system for reasonably calculating an automobile insurance premium using a smart card stored with motoring information, diagnosis information, and maintenance information of the automobile are disclosed. An insurance applicant accesses an insurance company server through a communication network by inserting the smart card into a predetermined terminal of PC. Based on the motoring information, diagnosis information, and maintenance information stored in the smart card, the automobile insurance premium is calculated. An insurance information applet from the insurance company server is downloaded and stored into the smart card. The insurance information applet further comprises first-aid information inputted by the insurance applicant, and uses such first-aid information when the traffic accident occurs.

### CROSS-REFERENCE TO RELATED APPLICATIONS

The present patent application claims priority from Korean Patent Application No. 2002-49534, filed on Aug. 21, 2002, which is incorporated herein by reference in its entirety.

### BACKGROUND OF THE INVENTION

1). Field of the Invention

The present invention relates to a method and system of calculating an automobile insurance premium using a smart card. More particularly, the present invention relates to a method and system of reasonably calculating an automobile insurance premium through a smart card recorded with motoring information, diagnosis information, and maintenance information of the automobile.

2). Discussion of Related Art

The conventional method for calculating premium of the automobile insurance has uniformly and in standardized fashion determined the automobile insurance premiums based mainly on the gender, age, a period of insurance, and traffic accident records, etc. as the calculation basis for the automobile insurance premium.

However, such method is an insurance premium calculation method that cannot sufficiently reflect driver's characteristics or condition of the insured vehicle. That is, in order for the automobile insurance premium to be calculated reasonably, it is desirable to use various factors in insurance premium calculation as below.

i) analysis of driver's driving tendency related to a traffic accident rate such as an abrupt acceleration, an abrupt deceleration, speeding, and etc.

ii) analysis of driver's driving time such as night driving having high frequency of accident risk

iii) analysis of how much driver drives such as short distance or long distance driving (the exposure to the traffic accident risk becomes higher as the mileage and driving time become longer)

iv) analysis of automobile diagnosis information that determines whether the automobile has trouble; and

v) analysis of a maintenance record and a replacement of articles of consumption that shows conditions of how driver manages his/her automobile.

However, the problem is that the current uniform automobile insurance calculation method does not consider such factors.

The present invention is intended to solve such problems of the conventional art, and characterized in that the information regarding the driver's driving tendency, the automobile diagnosis, the automobile's motoring, etc. is recorded in the smart card, and by using information recorded in such smart card at the time of taking out an automobile insurance policy, a reasonable automobile insurance premium calculation method and system using various information useful to the insurance calculation method are realized.

Korean Patent Application No. 2001-73195 entitled “System and Method for Collecting Vehicle Data and Diagnosing the Vehicle, and Method for Automatically Setting the Vehicle Convenience Apparatus Using Smart Card” which was filed on Nov. 23, 2001 by the applicant of the present invention discloses, in detail, the system related to a smart card for automobile and a smart card control unit used in the present invention.

The present invention is related to an improved invention using vehicle data collection and diagnosis system for the automobile insurance premium calculation according to a technique of the invention of the aforementioned patent application. The disclosure made in the aforementioned Korean Patent Application No. 2001-73195 is all incorporated in the present specification as references.

The vehicle data collection and diagnosis system disclosed in the aforementioned Korean Patent Application are summarized hereinbelow in reference to FIG. 1. FIG. 1 is a block diagram illustrating a constitution of vehicle data collection and diagnosis system 10 of the conventional art.

Referring to FIG. 1, the aforementioned vehicle data collection and diagnosis system 10 of the aforementioned invention comprises (i) a smart card control unit (SCU: 22) mounted in a vehicle 20, (ii) a terminal 40 of a vehicle repair shop, (iii) a personal terminal 50, and (iv) a central A/S center main server 60 for receiving information on a vehicle 20 from the repair shop terminal 40 or the personal terminal 50, and transferring desired vehicle diagnosis and repair data back to the repair shop terminal 40 and the personal terminal 50, which transfer information to each other by means of a smart card 30.

The vehicle 20 include the smart card control unit 22 in which such smart card control unit 103 collects and stores in the internal memory the latest information from electronic/mechanical control units and from sensors mounted in various vehicular devices, the vehicular normal and abnormal states indicated as error codes, and vehicular changed details indicated as input values for vehicle speed sensors, injector driving signals, and from the smart card 22, the latest vehicle maintenance information is collected, and updated in the internal memory, which is also recorded in the smart card 30.

Also, the control units such as Transmission Control Unit (TCU), Engine Control Unit (ECU) and the like, and various sensors are connected to the SCU 22 in parallel or serial so as to transfer to the SCU 22 and store in the internal memory data for all the details occurring in a vehicle 20 such as whether or not electronic control units are in malfunction, replacement periods for various articles of consumption, whether or not the engine is in malfunction, and so on, which are recorded in the smart card 30.

In the meantime, the repair shop terminal 40 includes the card terminal for reading from the smart card 30 and recording in the smart card vehicle-related data, and the computer connected to the card terminal and for analyzing the data read from the smart card 30, inputting and storing the details on whether or not a vehicle is in malfunction, articles of consumption replacement state indications, and vehicle maintenance. The personal terminal 120 includes the card terminal for reading and recording vehicle-related data from and into the smart card 30, and the maintenance program-installed computer connected to the card terminal and for indicting details on vehicle state diagnosis and maintenance recommendations off-line to enable self diagnosis.

In the mean time, the central A/S center main server 60 through a network 70 such as internet is connected to the repair ship terminal 40 and/or to the computer or the communication terminal of the personal terminal 50.

### SUMMARY OF THE INVENTION

The present invention suggests a method and system for calculating automobile insurance premium by using information related to vehicle which is recorded and collected from the vehicle data collection and diagnosis system of such as the aforementioned patent application.

One aspect of the present invention may be to implement a reasonable insurance premium calculation method and system by using information regarding the driver's driving tendency, the automobile diagnosis, and the automobile's maintenance history as the calculation basis for the automobile insurance premium.

Another aspect of the present invention may be to easily obtain the aforementioned various information by using the smart card control unit mounted on the vehicle with such various information and the smart card stored with information therefrom, and to implement a method and system to access to the automobile insurance company web site with the smart card stored with such information, and to easily transfer the aforementioned various information to the automobile insurance company server.

Another aspect of the present invention may be to implement a method and system to promptly obtain information regarding insurance policy held, its related information, and the first-aid information when the traffic accident occurs through the insurance information applet inserted in the smart card for automobiles.

In order to accomplish the above-mentioned object, the present invention provides a method for calculating an automobile insurance premium using a smart card stored with motoring information, diagnòsis information, and maintenance information of the automobile, comprising steps of (a) accessing an insurance company server through a communication network by an insurance applicant inserting the smart card into a predetermined terminal of PC; (b) selecting type of an automobile insurance desired by an insurance applicant; and (c) calculating automobile insurance premium based on the motoring information, diagnosis information, and maintenance information stored in the smart card.

Preferably, such motoring information includes at least one of data of mileage, of motoring time, and of speed such as an average speed, an abrupt acceleration, an abrupt deceleration, speeding, and etc.

More preferably, the diagnosis information is information regarding whether each unit of the automobile has trouble.

More preferably, the maintenance information is information regarding a maintenance record such as a replacement of articles of consumption, a change of parts, etc.

More preferably, the automobile includes a smart card control unit in which the smart card is inserted, and the motoring information and diagnosis information are stored in the smart card from electronic control units, mechanical control units, and sensors of the automobile via the smart card control unit.

More preferably, the maintenance information is stored in the smart card through a terminal of a vehicle repair shop at which the automobile has been repaired.

More preferably, the method for calculating insurance premium further comprising a step of downloading an insurance information applet from the insurance company server and storing the applet in the smart card.

In this regard, the insurance information applet includes at least one of information on the company of automobile insurance policy held, on the coverage particulars of the automobile insurance policy held, on the expiration of automobile insurance policy, contact numbers of the automobile insurance company and the agents, and insurance rate of the insured insurance policy.

The present invention may, for example, provide a method for settling a traffic accident using the smart card in which the insurance information applet is stored, and such insurance information applet includes a first-aid information inputted by an insurance applicant, and the method comprising steps of inserting the smart card into a terminal of PC or PDA when the traffic accident occurs; reading the insurance information and the first-aid information of an insurance policy-holder from the smart card; and transmitting a traffic accident settling record to the insurance company server.

The present invention may, for example, provide a system for calculating an automobile insurance premium using a smart card stored with motoring information, diagnosis information, and maintenance information of the automobile, which comprises a smart card control unit being installed in the automobile in which the smart card is inserted, extracting the motoring information and diagnosis information from electronic control units, mechanical control units, and sensors of the automobile, and storing them in the smart card; PC having access to the insurance company server through communication network by the smart card being inserted into a predetermined terminal; an insurance company server being connected to the PC through a communication network, calculating the automobile insurance premium based on the motoring information, diagnosis information, and maintenance information stored in the smart card, downloading an insurance information applet to the smart card, and storing it in the smart card.

### BRIEF DESCRIPTION OF THE DRAWINGS

FIG. 1 is a schematic block diagram for showing a vehicle data collection and diagnosis system of the conventional art.

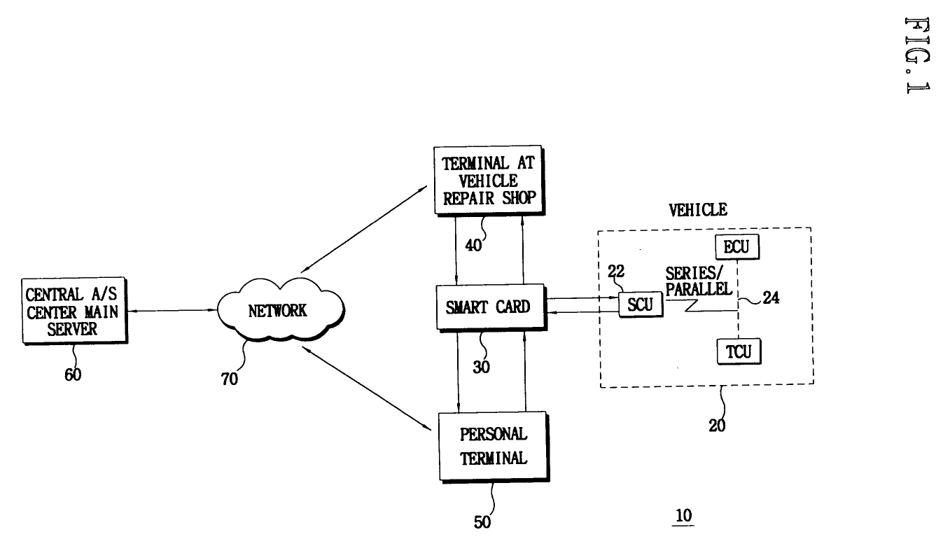

FIG. 2 is a block diagram for showing the internal structure of the smart card control unit according to the present invention.

FIG. 3 is a flow chart for illustrating a process for recording the motoring and diagnosis information of the automobile in the smart card according to the present invention.

FIG. 4 is a flow chart for illustrating a process for recording the maintenance information of the automobile in the smart card according to the present invention.

FIG. 5 is a schematic block diagram for showing the structure of the automobile insurance premium calculation system according to the present invention.

FIG. 6 is a flow chart for illustrating the automobile insurance premium calculation method according to the present invention.

FIG. 7 is a drawing illustrating the applet stored in the smart card according to the present invention.

FIG. 8 is a flow chart illustrating a process for using the insurance policy information of the smart card when the traffic accident occurs.

### DETAILED DESCRIPTION OF THE PREFERRED EMBODIMENTS

Hereinbelow, the preferred embodiments of the present invention are described with reference to the accompanying drawings.

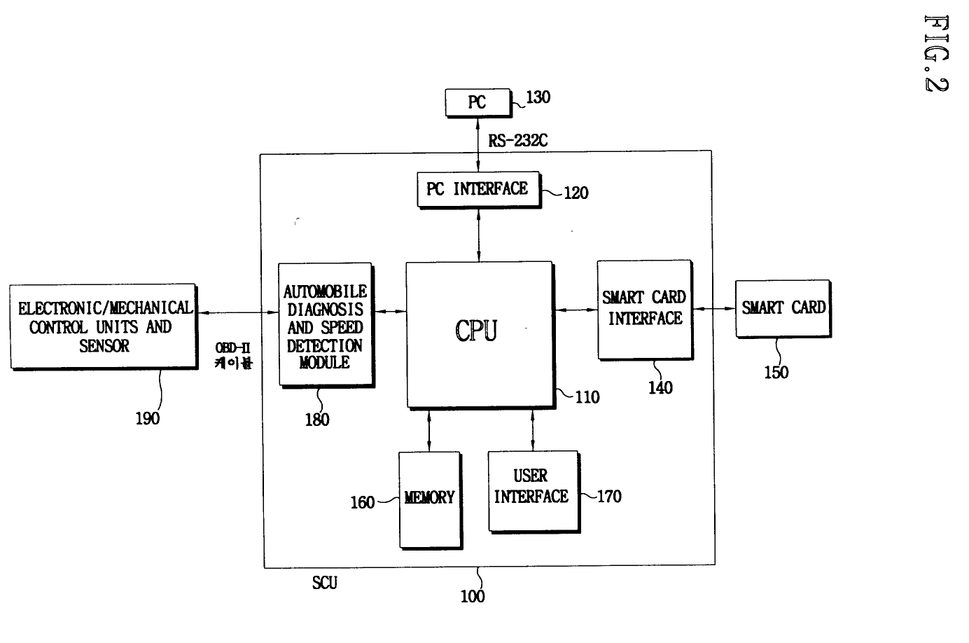

Before describing the automobile insurance premium calculation according to the present invention, the smart card control unit of the present invention used for recording automobile related information with the smart card or updating the maintenance information from the smart card is described. FIG. 2 is a block diagram for showing the internal structure of the smart card control unit 100 according to the present invention.

In reference to FIG. 2, the smart card control unit 100 of the present invention comprises a CPU 110, a PC interface 120, a smart card interface 140, a memory 160 inclusive of RAM and EEPROM, a user interface 170, and a automobile diagnosis and speed detection module 180.

The CPU 110 performs a comprehensive control process of the smart card control unit 100 as T89C51C101 which is a 8 bit 8051 Core CPU according to the preferred embodiment of the present invention.

The PC interface 120 can be connected by PC for external manager 130 and RSC-232C series port, and performs interface function between the smart card control unit 100 for installation and change of the program of the smart card control unit 100 and PC 130.

The smart card interface 140 inputs the automobile related information, driving tendency information, etc. with the smart card 150, and reads and updates data of the latest maintenance information, etc. from the smart card 15. The smart card interface 140 includes a smart card reader (TDA8029) which reads the smart card 150 and transfers the read information to the CPU 110. The smart card 150 is a smart card for automobile having security algorithm such as RSA, SHA-1, DES, Triple-DES, etc., which protects personal information of the card holder and the automobile related information so as to prevent illegal drain of such information.

The examples of the functions performed by the smart card interface 140 are; i) a function of prohibiting illegal use of the smart card by determining the legality of the inserted smart card, ii) a function of recording the total mileage of the automobile, personal mileage of the user etc., in the smart card, iii) a function of periodically recording the information of the driver's driving tendency such as the maximum/minimum speed, the average speed, the abrupt deceleration and abrupt acceleration in the smart card, and iv) a function of recording the malfunction code of the automobile (in such case, by recording the initial time of the occurrence of the malfunction, the driving speed at the time of malfunction, engine speed, etc. with regard to the malfunction code, the basic analysis data regarding the automobile malfunction can be provided).

The memory 160 of the smart card control unit 100 includes RAM temporarily storing the collected automobile diagnosis information or the automobile maintenance information, etc. from the smart card, ROM storing a program for controlling the CPU 110, and EEPROM storing the automobile's own basic information, automobile diagnosis information/driver's driving tendency information, and the automobile maintenance information, etc from the smart card.

The user interface 170 performs a function of providing the basic motoring information of the automobile (automobile speed, RPM, mileage, etc.) and operational condition of the smart card control unit 100 to the user, and can be realized as LCD or LED, etc. Also, the user interface 170 can perform an alarm function to notify the user when dangerous malfunction occurs or repair maintenance is needed.

According to the preferred embodiments of the present invention, the electronic, mechanical device and sensor 190 in the internal automobile such as ECU, TCU, ECS, ABS and air bag, etc. are connected to the automobile diagnosis and speed detection module 180 within the smart card control unit 100 through OBD-II cable, and such communication is made by K-LINE and L-LINE, which is the automobile information exchange communication protocols standardized in ISO 9141-2.

The automobile diagnosis and speed detection module 180 obtains the malfunction code, etc. from ECU, TCU, ECS, ABS and air bag, etc. and the information of the newly generated malfunction code is recorded in the smart card 150 through the smart card interface 140. Also, the module 180 by also acquiring information regarding the engine such as RPM, various temperature, etc. from the ECU, can obtain more detailed and objective driver's driving tendency than extracting the driver's driving tendency only from the simple automobile speed. Furthermore, the module 180 continuously monitors automobile's driving speed such as the maximum/minimum speed, the average speed, the abrupt acceleration, the abrupt deceleration, etc., and at regular hour, records in the smart card 150 through the smart card interface.

The smart card control unit 100 can also include a Real Time Clock (RTC). The RTC is an electronic digital clock used to generate data of the origination time of each driving tendency and of malfunction.

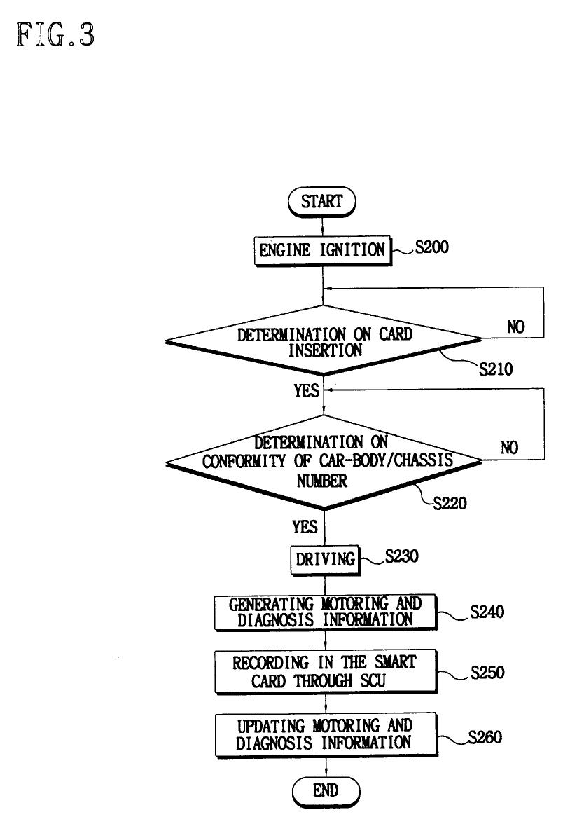

Next, referring to FIG. 3, the process to record automobile's motoring information (or driver's driving tendency) and automobile diagnosis information with the smart card is described. FIG. 3 is a flow chart for illustrating a process for recording the motoring and diagnosis information of the automobile in the smart card according to the present invention.

First of all, when the driver gets in the automobile and starts the engine (S200), the smart card control unit determines (S210) whether the smart card for automobile is inserted.

If the smart card is inserted in the smart card control unit, next, the smart card control unit determines (S220) whether the car-body/chassis number of the inserted smart card matches with itself. Such process is an authentication process to find out whether the inserted smart card belongs to the corresponding automobile.

When the card is not inserted or the car-body/chassis number does not match at the above step, the motoring information of the automobile and the diagnosis information are not stored in the smart card. If the card is inserted and the car-body/chassis number matches, the automobile can normally store the related information in the smart card (S230).

As the automobile is driven, the motoring information of the automobile and the diagnosis information are generated (S240). That is, the motoring information of the automobile is generated as driving speed data such as the average speed, the abrupt acceleration, the abrupt deceleration, speeding, etc., mileage data such as long distance driving and short distance driving, and driving time data such as day and night driving, etc., and such motoring information can be stored with designated time unit in the smart card control unit. Also, the automobile diagnosis information is generated from various electronic/mechanical control units and sensors, etc of the automobile, and such information is stored in the smart card control unit as error code, etc.

The motoring information and diagnosis information of the automobile collected by the smart card control unit as the above are recorded (S250) by the smart card, and the motoring information of the automobile and the diagnosis information stored accordingly in the smart card are updated (S260).

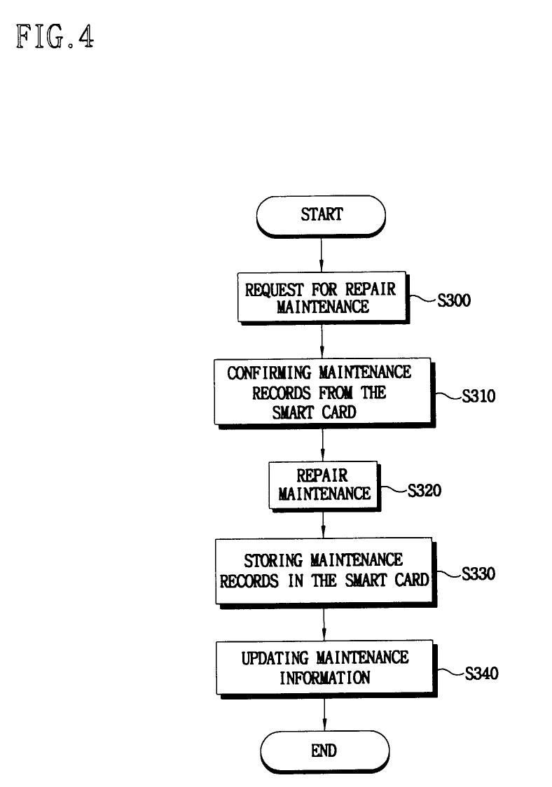

Next, referring to FIG. 4, a process of recording the maintenance information of the automobile (replacement of articles of consumption, etc.) by the smart card is described. FIG. 4 is a flow chart for illustrating a process for recording the maintenance information of the automobile in the smart card according to the present invention.

With reference to FIG. 4, the driver requests (S300) maintenance repair of his/her automobile at the vehicle repair shop. The vehicle repair shop can read the smart card for automobile according to the present invention, and equipped with the terminal for the vehicle repair shop to record information with such smart card.

The vehicle repair shop uses the terminal (inclusive of the smart card reader, etc.) to read the smart card of the client requesting the repair maintenance, and confirms the past automobile maintenance records of the corresponding automobile (S310). The maintenance records include details of auto parts, history of replacement of articles of consumption, etc.

After performing the repair maintenance (inclusive of the replacement of the parts) for the automobile (S320), the vehicle repair shop stores (S330) the performed maintenance records to the pertinent smart card using the terminal device, and the automobile maintenance information in the smart card is updated (S340).

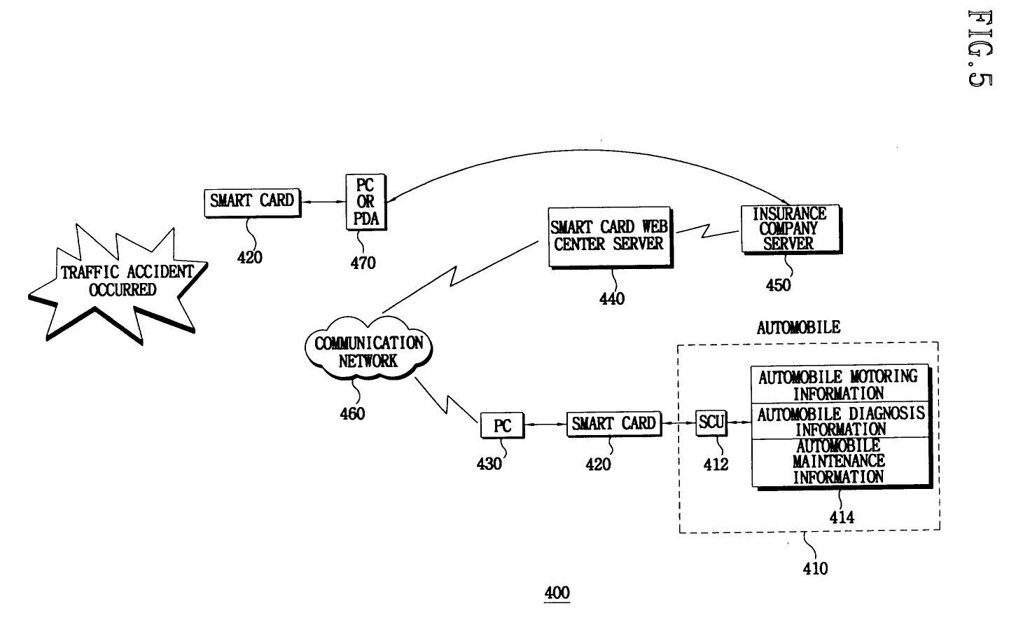

Hereinbelow, referring to FIGS. 5 to 7, the specific automobile insurance premium calculation according to the present invention is described.

FIG. 5 is a schematic block diagram for showing the structure of the automobile insurance premium calculation system according to the present invention.

With reference to FIG. 5, the automobile insurance premium calculation system 400 of the present invention comprises an automobile 410 mounted with the smart card control unit 412, a smart card 420 (according to process of FIGS. 3 & 4) recorded with the motoring, diagnosis and maintenance information of the automobile through the smart card control unit 412, PC 430, a smart card web center server 440 connected through the PC 430 and the communication network (a network such as internet, etc.), and an insurance company server 450.

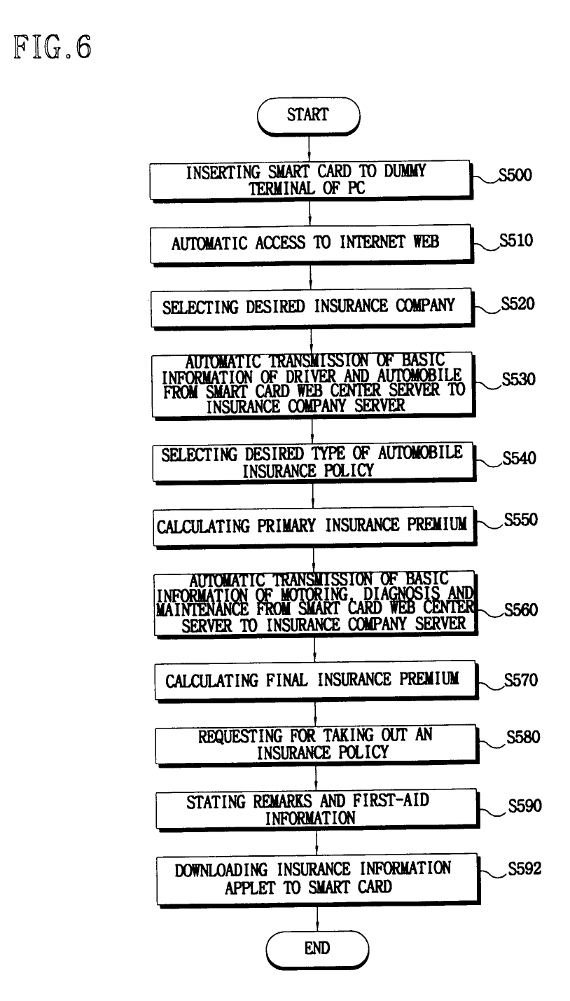

FIG. 6 is a flow chart for illustrating the automobile insurance premium calculation method according to the present invention. With reference to FIGS. 5 & 6, the automobile insurance premium calculation method according to the present invention is described.

Most of all, the insurance applicant desiring to take out an automobile insurance policy inserts (S500) his/her automobile smart card 420 to the dummy terminal of the PC 430, accordingly the web browser of the PC 430 is executed to automatically access to the smart card web center server 440, and the web site of the server 440 is displayed (S510) on the user web browser.

The PC 430 can be a personal PC or PDA, etc. of the insurance applicant, and the smart card 420 is recorded with automobile's motoring information, diagnosis information, and maintenance information (see process of FIGS. 3 & 4) through the smart card control unit 412 of the automobile 410, and also recorded with driver's personal information and basic information of the automobile.

The insurance applicant selects (S520) his/her choice of the automobile insurance company by a method such as clicking the company's banner, etc. from the web site, and concurrently with his/her selection, the driver's personal information and the basic information of the automobile are automatically transferred (S530) from the smart card web server 440 to the insurance company's server 450.

The driver's personal information and the basic information of the automobile transferred to the insurance company's server 450 include automobile information such as car-body/chassis number, automobile number, type of automobile, year of the manufacture, type of fuel, engine displacement, etc. and the driver's information such as applicant's name, social security number, address, telephone number, gender, age, etc. Accordingly, the insurance applicant is not required to input such information manually.

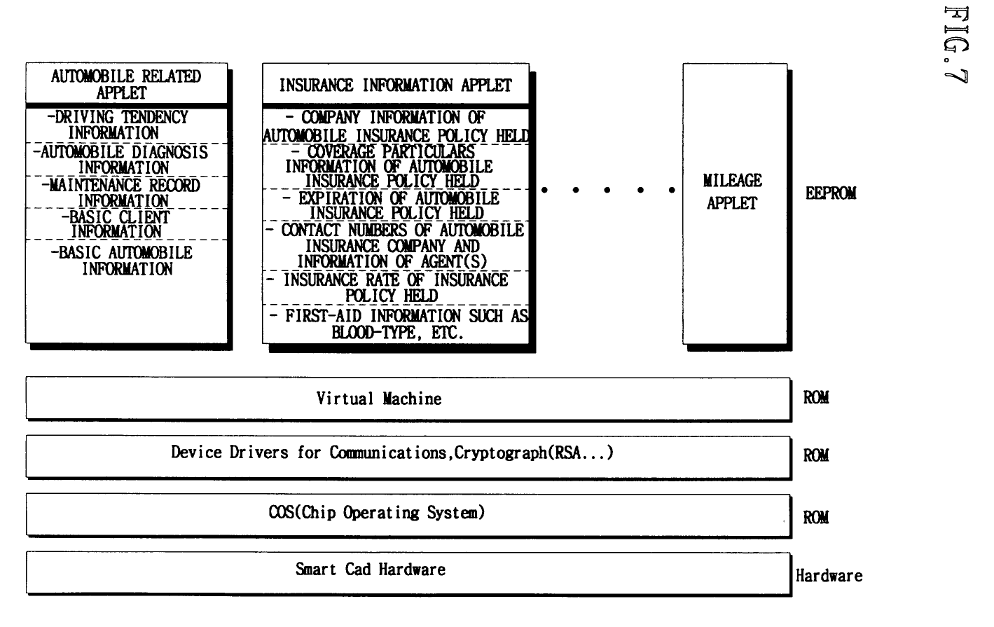

FIG. 7 is a drawing illustrating the applet stored in the smart card according to the present invention. Referring to FIG. 7, the driver's personal information and the basic information of the automobile are recorded in the smart card 420 in the form of an applet.

Next, the insurance applicant selects (S540) types of service of his/her choice of the automobile insurance policy. That is, the concrete automobile insurance policy choice coverages such as bodily injury liability, damages on substitutes, limitation on age and family membership, possibility on compensation for insurant's own automobile, etc. are inputted.

Thereafter, the concerned insurance company performs the primary insurance premium calculation (S550) of the insurance applicant based on a predetermined insurance premium calculation basis. The factors considered at the aforementioned initial insurance premium calculation are a period of insurance, driver's age, gender, history of accidents, etc., which are generally used in the conventional insurance premium calculation basis.

Next, the motoring information of the automobile (i.e., driver's driving tendency information), diagnosis information of the automobile, and the maintenance information of the automobile (including term for replacing article of consumption) read from the smart card 420 are automatically transmitted from the smart card web center server 440 to the insurance company server 450. Referring to FIG. 7, such motoring information, diagnosis information, and the maintenance information of the automobile are recorded in the smart card 420 in the applet form.

Then, the concerned insurance company server calculates the secondary insurance premium based on the aforementioned motoring information, diagnosis information, and the maintenance information of the automobile, and accordingly, the final calculation of the insurance premium is rendered (S570).

The example with regard to the secondary insurance premium calculation based on the aforementioned motoring information, diagnosis information, and the maintenance information of the automobile is described hereinbelow.

First of all, with regard to the motoring information of the automobile, if daily average automobile mileage and driving hours exceeds the ordinary figures, the insurance premium can be calculated expensive as there is a high risk of exposure to danger of accident. Also, if night driving, etc. is frequent, such may be the cause to trigger rise in the insurance premium.

The insurance premium calculation may differ according to the driver's driving tendencies. For example, if frequency of abrupt acceleration, abrupt deceleration, speeding, etc. exceeds the predetermined standard figure, the insurance premium may be calculated further expensive as the risk of accident is increased.

Next, with regard to the automobile diagnosis information, the trouble in the automobile parts may be the cause of triggering rise in the insurance premium, if automobile engine and various devices become obsolete, this may also be the cause of triggering rise in the insurance premium.

Further, with regard to the automobile maintenance information (which has been inputted from the terminal of the vehicle repair shop), maintenance records such as replacement periods for various articles of consumption including engine oil, mission oil, tire, etc. and whether the automobile maintenance was performed at appropriate time become the basis for the insurance premium calculation.

The aforementioned information which is the basis of the insurance premium calculation is compared to the predetermined standards, and addition/deduction from the aforementioned primary insurance premium calculation is made depending on whether the values of such information are higher or lower than the predetermined standards. That is, the insurance company server (450) includes information on the average values of each of values of the automobile motoring information, diagnosis information, and maintenance information as database, and such information on average values is compared to the information read from the concerned insurance holder's smart card to complete the secondary insurance premium calculation.

That is, according to the present invention, the aforementioned primary and secondary insurance premium calculations are all performed automatically according to the information read from the smart card without insurance holder's manual input. Also, information such as driver's driving tendencies, diagnosis and maintenance of automobile, etc. which was not used in the conventional automobile insurance premium calculation is used in the insurance premium calculation.

If the insurance applicant agrees to the amount of the finally calculated insurance premium presented thereto, the insurance applicant requests taking out an insurance policy (S580). After the completion of taking out the insurance policy, the insurance applicant inputs (S590) information such as his/her first-aid information including blood type, blood pressure, allergy, side effect to particular drug, etc. with input devices such as the keyboard of the PC 430 or the mouse, etc.

Then, the insurance information applet corresponding to the insurance policy holder from the insurance company server 450 is downloaded (S592) and recorded in the smart card 420.

The insurance information applet recorded in the smart card 420 is described in detail hereinbelow in reference to FIG. 7.

Referring to FIG. 7, information on company of automobile insurance policy held, on the coverage particulars of the automobile insurance policy held, on the expiration of automobile insurance policy, contact numbers of the automobile insurance company and the agents, and insurance rate stipulated by the company of automobile insurance policy held and first-aid information, etc. is stored in the smart card as the insurance information applet, and such information is downloaded from the insurance company server 450 from Step 592.

In the above preferred embodiment of the present invention, after the insurance applicant first make access to the smart card web center 440, the procedure to take out an insurance is carried out by accessing the insurance company server 450. Nevertheless, it is possible to take out the insurance policy using the smart card by directly accessing to the insurance company server 450 without connection to the smart card web center 440.

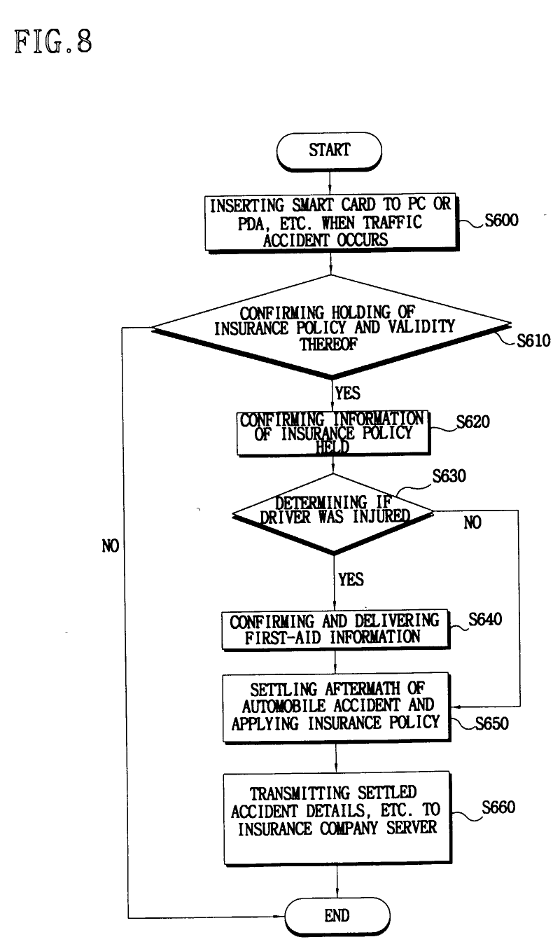

The use of the insurance information applet stored in the smart card as aforementioned at occurrence of automobile accident is described hereinbelow in reference to FIGS. 5 & 8. FIG. 8 is a flow chart illustrating a process for using the insurance policy information of the smart card when the traffic accident occurs.

After the automobile accident occurs, people who should be involved in settling the automobile accident such as the traffic policemen, etc. acquire the smart card from the smart card control unit 412 from the driver's automobile 410, and insert (S600) the smart card into the terminal of PC or PDA 470. The PC or PDA 470 used therein is stored with program that can interpret various applets of the smart card.

The PC or PDA 470 confirms (S610) whether the driver is insured or the validity of the driver's current insurance policy from the insurance information applet stored in the smart card of the driver's automobile who caused the accident. If the driver's insurance is valid, the driver's specific insurance information is read and confirmed (S620) from the smart card 420.

If the driver is injured so as to a first-aid treatment is required to apply to the driver who caused the accident (S630), the first-aid information of the insurance information applet stored in the smart card 420 is read, and the read first-aid information can be delivered to the doctor (S640).

Next, settling the aftermath of the automobile accident and the pertinent insured insurance are applied (S650) by using the insurance policy held which is read from the insurance information applet of the above smart card 420, and the settled accident details are transferred (S660) to the insurance company server 450.

As can be seen from the above steps, the smart card for automobile according to the present invention is stored with the insurance information applet inclusive of information of insurance policy held and of first-aid, which enables a prompt process by the automobile accident insurance, and easier acquisition of information from the smart card necessary for the injured who need first-aid treatment.

Although the preferred embodiments of the present invention have been described, it will be understood by those skilled in the art that the present invention should not be limited to the described preferred embodiments, but various changes and modifications can be made within the spirit and scope of the present invention as defined by the appended claims.

As aforementioned, according to the present invention, the object of the present invention is to render an effect of realizing a rather reasonable calculation method by using information of driver's driving tendencies, of automobile diagnosis, and of overhaul history of the automobile as the basis of automobile insurance premium calculation.

That is, in the insurance company's point of view, the company applies cheap insurance premium to the customers having low accident risk rate, and a reasonable insurance premium to the customers with high accident risk rate in order to attract customers with a reasonable marketing strategy. Accordingly, a superior service through making a sound finance can be furnished to the customers.

Moreover, as the insurance premium is calculated according to the driver's driving tendencies and overhaul habit, the driver may improve his/her own driving tendencies and overhaul habit in order not to get highly calculated insurance, which provides an effect of remarkably reducing the rate of the automobile accident.

Further, without the manual input of the insurance applicant, the smart card is used to perform automatic insurance premium calculation, which is a convenient advantage for taking out the insurance from the standpoint of the insurance applicant.

Also, by the insurance information applet mounted in the smart card for automobile, information concerning whether the insurance has been bought at the time of automobile accident, concerning any related matters and concerning first-aid are obtained to provide an effect of securing prompt settling of the automobile and appropriateness of the first-aid treatment.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method for calculating an automobile insurance premium using a smart card stored with motoring information, diagnosis information, and maintenance information of the automobile, comprising the steps of:
(a) accessing an insurance company server through a communication network by an insurance applicant inserting said smart card into a predetermined terminal of a PC;
(b) selecting a type of an automobile insurance desired by an insurance applicant; and
(c) calculating an automobile insurance premium based on said motoring information, diagnosis information, and maintenance information stored in said smart card.

2. The method as claimed in claim 1, wherein said motoring information includes at least one of data of mileage, of motoring time, and of speed.

3. The method as claimed in claim 1, wherein said diagnosis information is information regarding whether each unit of the automobile has trouble.

4. The method as claimed in claim 1, wherein said maintenance information is information regarding a maintenance record.

5. The method as claimed in claim 1, wherein said automobile includes a smart card control unit in which said smart card is inserted, and said motoring information and diagnosis information are stored in said smart card from electronic control units, mechanical control units, and sensors of said automobile via said smart card control unit.

6. The method as claimed in claim 1, said maintenance information is stored in said smart card through a terminal of a vehicle repair shop at which said automobile has been repaired.

7. The method as claimed in claim 1, further comprising a step of:
(d) downloading an insurance information applet from said insurance company server and storing the applet in said smart card.

8. The method as claimed in claim 7, wherein said insurance information applet includes at least one of information on company of automobile insurance policy held, on the coverage particulars of the automobile insurance policy held, on the expiration of automobile insurance policy, contact numbers of the automobile insurance company and the agents, and insurance rate of the insured insurance policy.

9. A method for settling a traffic accident using the smart card in which said insurance information applet is stored by the method according to claim 7, said insurance information applet includes a first-aid information inputted by an insurance applicant, and said method comprising steps of:
inserting said smart card into a terminal of at least one of a PC and PDA when the traffic accident occurs;
reading the insurance information and the first-aid information of an insurance policy-holder from said smart card; and
transmitting a traffic accident settling record to said insurance company server.

10. A system for calculating an automobile insurance premium using a smart card stored with motoring information, diagnosis information, and maintenance information of the automobile, comprising:
a smart card control unit being installed in the automobile in which said smart card is insertable, extracting said motoring information and diagnosis information from electronic control units, mechanical control units, and sensors of said automobile, and storing them in said smart card;
a PC having access to the insurance company server through a communication network by said smart card being inserted into a predetermined terminal; and
an insurance company server being connected to said PC through a communication network, calculating the automobile insurance premium based on said motoring information, diagnosis information, and maintenance information stored in said smart card, downloading an insurance information applet to said smart card, and storing in the said smart card.

11. The method of claim 2 wherein the data is speed data, including at least one of an average speed, an abrupt deceleration, and speeding.

12. The method of claim 4, wherein the maintenance record includes at least one of (i) replacement of articles of consumption, and (ii) change of parts.
